(19) United States
(12) Patent Application Publication
(10) Pub. No.: US 2006/0250434 A1
(43) Pub. Date: Nov. 9, 2006

(54) Determining an energy delivered to a fluid

(76) Inventors: David E. Smith, Vancouver, WA (US); Kenneth B. Wade, Battle Ground, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/122,961

(22) Filed: May 5, 2005

(51) Int. Cl. B41J 29/38

(52) U.S. Cl. 347/17

(57) ABSTRACT

Embodiments disclose determining an energy delivered to a fluid using a measurement of power supplied to a dryer and an efficiency value.

### BACKGROUND

Some ink-jet imaging systems, such as printers, use convection dryers to dry a marking fluid, such as ink, after it is deposited on a media sheet, such as paper. In some systems, the temperature of the heated air is not well correlated with the degree of marking fluid dryness and inadequate drying often results. Inadequate drying can result in output of wet media that can jam the imaging device or contaminate the media path with ink.

### DESCRIPTION OF THE DRAWINGS

FIG. 1 is a block diagram of an embodiment of an imaging device, according to an embodiment of the present disclosure.

FIG. 2 is a block diagram of an embodiment of a drying system, according to another embodiment of the present disclosure.

### DETAILED DESCRIPTION

In the following detailed description of the present embodiments, reference is made to the accompanying drawings that form a part hereof, and in which is shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

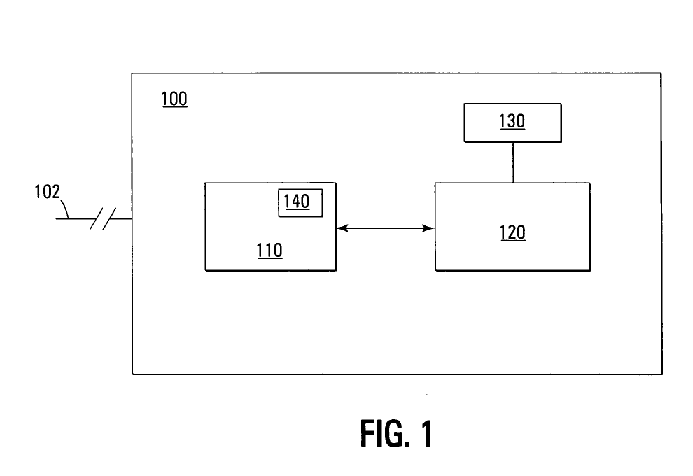

FIG. 1 is a block diagram of an imaging device 100, such as an ink-jet imaging device, according to an embodiment. Imaging device 100 can be a printer, a copier, digital network copier, a multi-function peripheral (MFP), a facsimile machine, etc. Imaging device 100 may be connected directly to a personal computer, workstation, or other processor-based device system, or to a data network, such as a local area network (LAN), the Internet, a telephone network, etc., via an interface 102.

For one embodiment imaging device 100, receives image data via interface 102. Imaging device 100 has a main controller 110, such as a formatter or a print engine controller, for interpreting the image data and rendering the image data into a printable image. The printable image is provided to a print engine 120 to produce a hardcopy image on a medium, such as a media sheet. For one embodiment, the imaging device 100 is capable of generating its own image data, e.g., a copier via scanning an original hardcopy image. Imaging device 100 also includes a drying system 130 for drying fluid, such as a marking fluid, deposited on the media sheets. For another embodiment, drying system 130 is controlled by controller 110. For another embodiment, drying system 130 is a subsystem of print engine 120.

Controller 110 includes a memory 140, e.g., a computer-usable storage media that can be fixedly or removably attached to controller 110. Some examples of computer-usable media include static or dynamic random access memory (SRAM or DRAM), read-only memory (ROM), electrically-erasable programmable ROM (EEPROM or flash memory), magnetic media and optical media, whether permanent or removable. Memory 140 may include more than one type of computer-usable storage media for storage of differing information types. For one embodiment, memory 140 contains computer-readable instructions, e.g., drivers, adapted to cause controller 110 to format the data received by imaging device 100, via interface 102 or by scanning, and computer-readable instructions to cause imaging device 100 to perform the various methods described below.

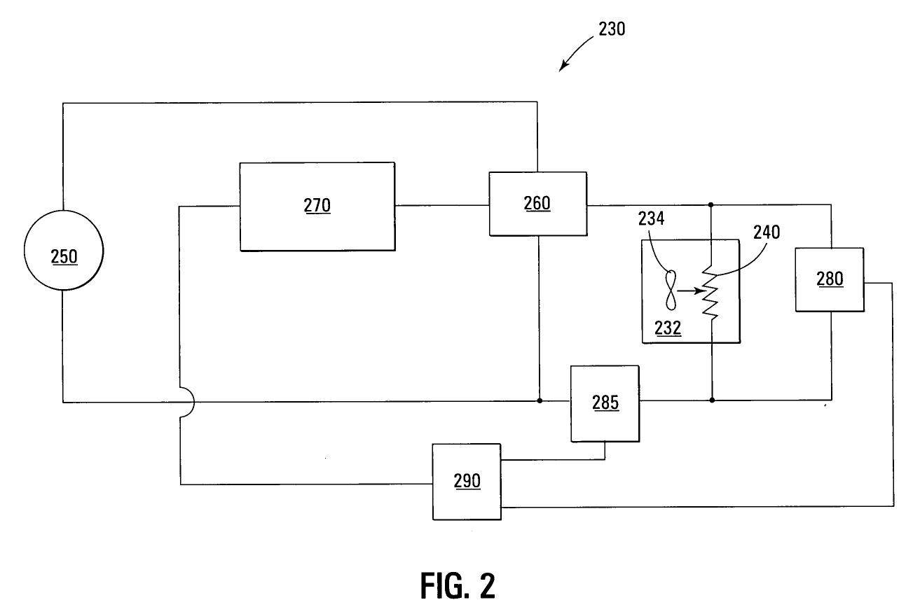

FIG. 2 is a block diagram of a drying system 230 as a portion of an imaging device, such as imaging device 100 of FIG. 1, according to an embodiment. An embodiment of a drying system, such as drying system 230 includes a dryer 232 that for one embodiment has fan 234 that blows air across a heating element 240 and onto a media sheet (not shown) for drying a marking fluid that has been deposited thereon. A power supply 250, e.g., AC or DC, supplies power to heating element 240. For one embodiment, power supply 250 is an AC Mains voltage. For another embodiment, power supply 250 is connected to a power controller 260. For one embodiment, power controller 260 includes solid-state Triacs. For another embodiment, heating element 240 is a radiant heater that can dry the marking fluid without fan 234. Power controller 260 is connected to a drying system controller 270 that controls the operation of drying system 230. For one embodiment, drying system controller 270 may be part of a main controller of the imaging device, such as main controller 110 of imaging device 100, or independent of the main controller and connected thereto.

A voltage sensor 280 is connected across heating element 240, and a current sensor 285 is connected in series with voltage sensor 280 and heating element 240. A power measurement block 290 is connected to current sensor 285 and voltage sensor 280 and to drying system controller 270. For one embodiment, current sensor 285 may be a calibrated sense resistor having a predetermined resistance value connected in series with heating element 240, and the current through current sensor 285 and thus through heating element 240 is determined by measuring a voltage drop across the sense resistor and using Ohms law with the measured voltage drop and the predetermined resistance value.

Power measurement block 290 receives inputs respectively indicative of the current flowing through heating element 240 and the voltage drop across heating element 240. For one embodiment, power measurement block 290 includes an analog-to-digital (A/D) converter for digitizing these inputs. For some embodiments, power measurement block 290 is integrated within drying system controller 270. Power measurement block 290 includes a signal multiplier that multiplies the inputs indicative of the current flowing through heating element 240 and the voltage drop across heating element 240 for computing the actual power supplied to heating element 240 during a time relatively short time interval. For one embodiment, power measurement block 290 sends a signal indicative of the actual power to drying system controller 270 during a relatively short time interval.

In operation, for one embodiment, drying system controller 270 instructs power controller 260 to allow power to be supplied from power supply 250 to heating element 240. Moreover, drying system controller 270 activates fan 234 for some embodiments. Signals indicative of the current flowing through heating element 240 and the voltage drop across heating element 240 are then respectively sent from current sensor 285 and voltage sensor 280 to power measurement block 290. Power measurement block 290 multiplies the signals together to compute the power supplied to heating element 240 during a relatively short time interval and sends a signal indicative of the power supplied to heating element 240 to drying system controller 270. For one embodiment, a power value is computed at power measurement block 290 and sent to drying system controller 270 for each of a plurality of time intervals.

Drying system controller 270 then determines the energy Eᵢ delivered to the marking fluid deposited on a media sheet for drying (or vaporizing) the marking fluid deposited on a media sheet for each of the time intervals from
Eᵢ=Pᵢ*(η*Δtᵢ) (1)
where Pᵢ is the power value computed at power measurement block 290 for the ith time interval, Δtᵢ is the length of the ith time interval, and η is an efficiency value, such as an overall drying efficiency, that accounts for losses in the dryer 232, heat lost into the media, the media type, etc. The energy delivered to the marking fluid for a number of time intervals can then be determined by summing the energies delivered during each of the number time intervals over the number of time intervals. For one embodiment, drying system controller 270 forms a running total of the energy delivered to the marking fluid deposited on the media sheet by adding the energy delivered during each successive time interval to the energy delivered to the marking fluid during the preceding time intervals. For example, for N time intervals, the running total of the energy is formed by adding an energy E_{N} delivered during the Nth time interval to the energy delivered during the N−1 preceding time intervals as follows:
Eᵣᵤₙ=(E₁+E₂+ . . . +E_{N-1})+E_{N} (2)

For one embodiment, drying system controller 270 determines a volume of ink deposited on a media page. For another embodiment, the volume of ink deposited on the media page is determined from the image data, e.g., a bitmap or the like, corresponding to the image to be printed that is sent to the main controller from a host computer. Drying system controller 270 then determines the total amount of energy to be used to dry the marking fluid (or vaporize liquid contained in the making fluid) deposited on the media sheet based on the determined volume of ink and thermophysical properties of the marking fluid. For some embodiments, determining the total amount of energy to be used to dry the marking fluid deposited on the media sheet based on the determined volume of ink includes going into a look-up table corresponding to the particular media type and/or marking fluid type with the determined volume of ink and retrieving the amount of energy to be used to dry the marking fluid corresponding to that volume and that media type. For one embodiment, the look-up table may be contained in memory 140.

Drying system controller 270 then determines whether Eᵣᵤₙ is sufficient for drying the marking fluid. For one embodiment, this is accomplished by comparing the total amount of energy to be used for drying the marking fluid to Eᵣᵤₙ after each time interval. When Eᵣᵤₙ is substantially equal to or greater than the total amount of energy to be used for drying the marking fluid, drying system controller 270 instructs power controller 260 to stop power from being supplied, or reduce power being supplied in some embodiments, from power supply 250 to heating element 240. Otherwise, the power continues to be supplied to heating element 240 for additional time intervals as appropriate, and Eᵣᵤₙ is updated by adding the energy supplied during the additional time intervals and compared to the amount of energy to be used for drying the marking fluid.

For various embodiments, the efficiency η can be determined experimentally for various fan speeds, dryer geometries, media types, relative humidity, marking fluid type, etc. For one embodiment, this may involve depositing a predetermined amount of marking fluid on a media sheet and drying the ink for a preselected time period at a preselected power, where the length of the preselected time period may or may not be sufficient for completely drying the marking fluid. At the end of the preselected time period, the media sheet is weighed to determine the amount of drying, i.e., the amount marking fluid evaporated. The efficiency η can then be determined from
η=E/(PΔt) (3)
where E is the energy that goes into evaporating the marking fluid, calculated from thermophysical properties of the marking fluid and the amount of marking fluid evaporated, P is the preselected power, Δt is the length of the preselected time period, and PΔt is the energy input to the dryer during Δt. Note that an average power P_{AV} can be used for P, where the average power is determined from
P_{AV}=(P₁Δt₁+ . . . +P_{M}Δt_{M})/(Δt₁+ . . . +Δt_{M}) (4)
and where (Δt₁+ . . . +Δt_{M})=Δt and P₁, . . . , and P_{M} are the powers measured during the respective time intervals and corresponding to Δt₁, . . . , and Δt_{M}. For one embodiment, the powers can be measured as described above.

Note that drying system controller 270 may select an efficiency based on the particular a fan speed, dryer geometry, relative humidity, marking fluid type, and/or media type, for various embodiments. For these embodiments, drying system controller 270 would receive inputs indicative of fan speed, dryer geometry, relative humidity, marking fluid type, and/or media type. For one embodiment, the fan speed, dryer geometry and/or marking fluid type may be fixed. For another embodiment, the imaging device may include sensors for sensing the media type and/or the relative humidity. Since it may not be practical to obtain efficiency data for every possible relative humidity, drying system controller 270 may interpolate an efficiency at the measured relative humidity of the surroundings from efficiencies at other relative humidities prestored in a look-up table, e.g., contained in memory 140, for some embodiments. This could also be done for fan speed and/or marking fluid type for one embodiment.

### CONCLUSION

Although specific embodiments have been illustrated and described herein it is manifestly intended that the scope of the claimed subject matter be limited only by the following claims and equivalents thereof.

What is claimed is:

1. A method, comprising:
determining an energy delivered to a fluid on a medium using a measurement of power supplied to a dryer of an imaging device and an efficiency value.

2. The method of claim 1, wherein the measurements of power supplied to the dryer comprise measurements of voltage drops across the dryer and measurements of current flows through the dryer.

3. The method of claim 2, wherein the measurements of current flows through the dryer comprise measurements of voltage drops across a sense resistor connected in series with the dryer.

4. The method of claim 1 further comprises comparing the energy delivered to the fluid to an energy to be used to dry the fluid.

5. The method of claim 4 further comprises determining the energy to be used to dry the fluid.

6. The method of claim 5, wherein determining the energy to be used to dry the fluid comprises determining an amount of the fluid deposited on the medium.

7. The method of claim 1 further comprises determining the efficiency value based on at least one of a fan speed, dryer geometry, media type, relative humidity, and marking fluid type.

8. The method of claim 1, wherein the measurement of power includes a plurality of measurements of powers during a plurality of time intervals, wherein the medium includes a sheet of media.

9. The method of claim 1 further comprises reducing the power supplied to the dryer when the energy delivered to the fluid is sufficient to dry the fluid.

10. A method of operating an imaging device, comprising:
measuring power supplied to a dryer during time intervals;
determining energies delivered to a marking fluid deposited on a media sheet during individual of the time intervals using the power supplied to the dryer during the individual of the time intervals and a drying efficiency;
summing the energies delivered to the marking fluid during the time intervals; and
determining whether the amount of energy delivered to the marking fluid during the time intervals is sufficient to dry the marking fluid.

11. The method of claim 10, wherein determining whether the amount of energy delivered to the marking fluid during the time intervals is sufficient to dry the marking fluid comprises comparing the amount of energy delivered to the marking fluid during the time intervals to an energy to be used to dry the marking fluid deposited on the media sheet.

12. A method for determining a drying efficiency, comprising:
determining an amount of energy supplied to a dryer during a time interval;
determining an amount of fluid evaporated from a media sheet during the time interval by the dryer;
computing an energy used to evaporate the amount of the fluid; and
forming a ratio of the energy used to evaporate the amount of the fluid to the amount of energy supplied to the dryer.

13. The method of claim 12, wherein the method is performed for at least one of different fan speeds, dryer geometries, media types, relative humidities, and fluid types.

14. The method of claim 12, wherein determining the amount of the energy supplied to the dryer during the time interval comprises measuring the power supplied to the dryer during the time interval and multiplying that power by the time interval.

15. The method of claim 12, wherein determining the amount of fluid evaporated from the media sheet during the time interval comprises depositing a predetermined amount of the fluid on the media sheet and weighing the media sheet after the end of the time interval.

16. A computer-usable medium containing computer-readable instructions to perform a method comprising:
determining an energy delivered to a fluid on a media using a measurement of power supplied to a dryer of an imaging device and an efficiency value.

17. The computer-usable medium of claim 16, wherein the method further comprises comparing the energy delivered to the fluid to an energy to be used to dry the fluid.

18. The computer-usable medium of claim 17, wherein the method further comprises determining the energy to be used to dry the fluid.

19. The computer-usable medium of claim 18, wherein, in the method, determining the energy to be used to dry the fluid comprises determining an amount of the fluid deposited on the media.

20. The computer-usable medium of claim 16, wherein the method further comprises selecting the drying efficiency based on at least one of a fan speed, dryer geometry, media type, relative humidity, and marking fluid type.

21. The computer-usable medium of claim 16, wherein, in the method, the measurement of power includes a plurality of measurements of powers during a plurality of time intervals, wherein, in the method, the media includes a sheet of media.

22. The computer-usable medium of claim 16, wherein the method further comprises reducing the power supplied to the dryer when the energy delivered to the fluid is sufficient to dry the fluid.

23. A drying system comprising:
a means for measuring power supplied to a dryer at each of a plurality of time intervals; and
a means for determining an energy delivered to a marking fluid deposited on a media sheet during each of the time intervals from the power supplied to the dryer during that time interval and a drying efficiency.

24. The drying system of claim 23 further comprises a means for summing the energies delivered to the marking fluid during the respective time intervals to determine an amount of energy delivered to the marking fluid during the plurality of time intervals.

25. The drying system of claim 23 further comprises a means for determining whether an amount of energy delivered to the marking fluid during the plurality of time intervals is sufficient to dry the marking fluid.

26. The drying system of claim 23 further comprises a means for determining an amount of energy for drying the marking fluid.

27. The drying system of claim 23 further comprises a means for selecting the drying efficiency.

28. A drying system of an imaging device, comprising:
a dryer;
a voltage sensor to measure a voltage across the dryer;
a current sensor to measure a current through the dryer; and
a controller configured to determine an energy supplied to a fluid on a media sheet during individual of one or more time intervals using a drying efficiency, the current during the time interval, and the voltage during the time interval.

29. The drying system of claim 28 further comprises a measuring block connected to the controller, the current sensor, and the voltage sensor configured to compute a power during each of the one or more time intervals by multiplying the current sensed during that time interval by the current sensor and the voltage sensed during that time interval by the voltage sensor, wherein the controller computes the energy supplied to the marking fluid during each of the one or more time intervals from that power, wherein the measuring block further comprises an analog-to-digital converter.
